(19) United States
(12) Patent Application Publication
(10) Pub. No.: US 2008/0191601 A1
(43) Pub. Date: Aug. 14, 2008

(54) Fluorescent Lamp for Inspecting Color Printed Matters

(75) Inventor: Jan Pieter Dekker, Roosendaal (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,227

(22) PCT Filed: Apr. 5, 2006
(86) PCT No.: PCT/IB06/51042

§ 371 Date: Oct. 11, 2007

(30) Foreign Application Priority Data
Apr. 14, 2005 (EP) 05102961.9

(51) Int. Cl. C09K 11/08

(52) U.S. Cl. 313/486

(57) ABSTRACT

The invention relates to a fluorescent lamp (1) comprising a glass envelope (3) coated with one or more phosphor containing layers (4) and filled with a gas (7), said fluorescent lamp further comprising means (6) capable of discharging said gas. The composition of said phosphor containing layer is tailored to obtain a special color rendering index higher than 93 for at least printing primary colors cyan, magenta and yellow. The lamp is particularly suitable for inspection of color-printed matters in the graphical industry.

### FIELD OF THE INVENTION

The invention relates to such a fluorescent lamp for inspecting color-printed matters. More specifically, the invention relates to a fluorescent lamp for this purpose comprising a glass envelope coated with at least one phosphor containing layer and filled with a gas, said fluorescent lamp further comprising means capable of discharging said gas.

### BACKGROUND OF THE INVENTION

For lamps in inspection applications, it is important to evaluate how well a given illumination can render colors of objects in the illuminated scene. The Commision Internationale de L'Eclairage (CIE) defined a color rendering index. The procedure of calculation, as generally known in the art, is first to calculate the color differences ΔEᵢ of a carefully selected eight or fourteen samples between the conditions when illuminated by a reference lamp and when illuminated by the lamp under consideration. Then a special color rendering index Rᵢ is calculated by

Rᵢ=100−4.6ΔEᵢ

This gives an indication of the color rendering for each particular color. The general color rendering index Rₐ is the average of the first eight color samples. With the maximum value being 100, Rₐ gives a scale that matches well with the visual impression of color rendering. For example, lamps having Rₐ values greater than 80 may be considered suitable for interior lighting and Rₐ greater than 90 for visual inspection purposes. GB 1 354 315 discloses a fluorescent lamp comprising a glass tube with a layer of blended phosphor containing four kinds of phosphors on the inside surface thereof to give a color rendering value R₁>95. The high color rendering fluorescent lamp is proposed to be used as a light source for inspecting color-printed matters.

### SUMMARY OF THE INVENTION

It is an object of the invention to provide an improved fluorescent lamp for inspecting color-printed matters.

This object is accomplished by a fluorescent lamp comprising a glass envelope coated with one or more phosphor containing layers and filled with a gas, said fluorescent lamp further comprising means capable of discharging said gas, wherein the composition of said phosphor containing layer is tailored to obtain a special color rendering index higher than 93 for at least printing primary colors cyan, magenta and yellow.

CMYK is a color model used in color printing industry. This color model is based on mixing pigments of cyan (C), magenta (M), yellow (Y) and black (K). In CMYK, magenta plus yellow generates red, magenta plus cyan generates blue, cyan plus yellow generates green and the combination of cyan, magenta and yellow generates black. Since this black color is not deep black as compared to black ink, four color printing uses black ink in addition to CMY.

The applicant has realized that the printing color primaries cyan, magenta and yellow are not part of the samples used in determining the general color rendering index Rₐ. Accordingly, the value of the general color rendering index Rₐ as used in the prior art is an inappropriate measure to define the suitability of a fluorescent lamp for inspecting color printed matters. By tailoring the composition of the one or more phosphor containing layers with respect to the reflectance spectra of the printing color primaries as e.g. provided in the draft international standard ISO/DIS 2846-5 of 2003, a special color rendering index Rᵢ larger than 93 can be obtained for cyan, magenta and yellow. A fluorescent lamp with such characteristics is advantageously applied in the graphical industry for inspection of color-printed matters.

The compositions for a blend of the phosphor containing layer include at least six phosphors. Preferred examples are defined in claim 3.

The invention further relates to the use of such a lamp in the graphical industry for inspecting color-printed matters.

The invention will be further illustrated with reference to the attached drawings, which schematically show a preferred embodiment according to the invention. It will be understood that the invention is not in any way restricted to this specific and preferred embodiment.

### BRIEF DESCRIPTION OF THE DRAWINGS

In the drawings:

FIG. 1 shows reflection spectra for the eight different standard colors and cyan, magenta and yellow, and

FIG. 2 shows a fluorescent lamp with a phosphor containing layer according to an embodiment of the invention.

### DETAILED DESCRIPTION OF THE DRAWINGS

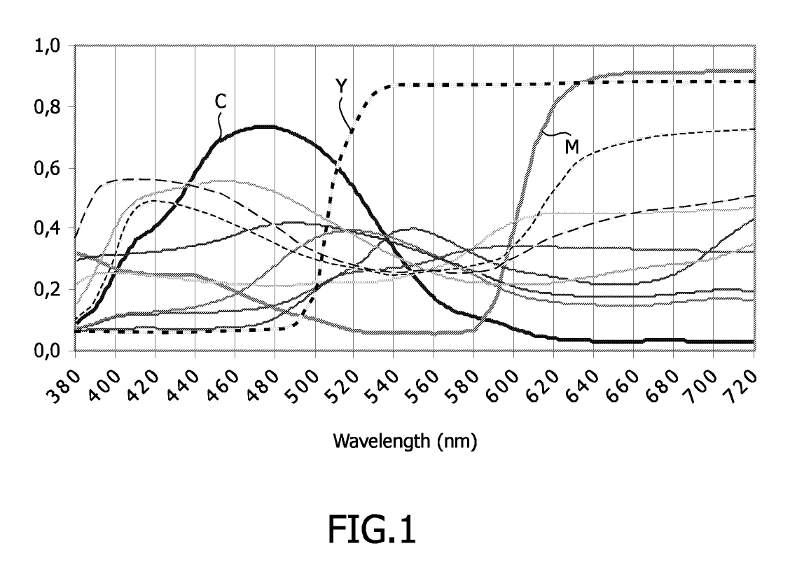

FIG. 1 shows reflection spectra for the eight different standard colors. Along the horizontal axis, wavelengths are indicated whereas along the vertical axis the reflectance in arbitrary units is displayed. Typically, fluorescent lamps are optimized with respect to their color rendering by using the eight samples defined by the Commision Internationale de L'Eclairage (CIE). In general, the resulting phosphor blends for these fluorescent lamps are a compromise to fit the individual colors best.

The international organization for standardization issued a draft international standard in 2003 for the use of printing ink for four color printing. Said standard is ISO/DIS 2846-5 “Graphic Technology—Color and transparency of printing ink sets for four color printing” of which annex B has been used to depict FIG. 1. As can be observed from FIG. 1, the reflection spectra for cyan (C), magenta (M) and yellow (Y) are different from the reflection spectra for determining Rₐ. Consequently, the specific color rendering indices R_{C}, R_{M} and R_{Y} for cyan, magenta and yellow respectively are not optimal.

According to an aspect of the invention, the reflection spectra for C, M and Y have been used to perform calculations to tailor the composition of the one or more of the phosphor containing layers to optimize the specific color rendering indices R_{C}, R_{M} and R_{Y} for cyan, magenta and yellow. First the weight contribution of the phospors is taken equal. The individual known lamp spectra for the phospors are input. It is noted that these lamp spectra are preferred over the phosphor powder spectra as the lamp spectra already include the mercury lines. Then a numerical multi parameter equation is solved considering the individual phosphor spectra and the desired conditions such as white color point at designated correlated color temperature and individual R_{C,M,Y} larger than 93. From these calculations, special color rendering indices R_{C}, R_{M} and R_{Y} for cyan, magenta and yellow were obtained all having values higher than 93, preferably 93.5, preferably 94, preferably 95, preferably 96, preferably 97, preferably 98, including the lower limits itself.

From the calculations, given a correlated color temperature (CCT) of 5000K, examples of such compositions include the following

| | Weight ratio | Weight ratio | Weight ratio |
|---|---|---|---|
| Phosphor | | | |
| Ca₁₀(PO₄)₆F₂:Sb | 0.126 | 0.126 | 0.334 |
| Ca₁₀(PO₄)₆(F,Cl)₂:Sb,Mn | 0.292 | 0.328 | 0.212 |
| (Ce,Gd)MgB₅O₁₀:Tb | 0.039 | | |
| (Ce,Gd,Tb)MgB₅O₁₀:Mn | 0.352 | 0.348 | 0.248 |
| Sr₄Al₁₄O₂₅:Eu | 0.169 | 0.155 | 0.077 |
| BaMgAl₁₀O₁₇:Eu | 0.023 | 0.166 | |
| BaMg₂Al₁₆O₂₇:Mn | | 0.186 | 0.398 |
| Y₂O₃:Eu | | | 0.063 |
| Computed values | | | |
| Rₐ | 97 | 97 | 95 |
| R_{C} | 94.5 | 97.3 | 95 |
| R_{M} | 95.3 | 95.6 | 95 |
| R_{Y} | 95 | 95 | 95 |
| R_{CMY} | 94.9 | 96.0 | 95 |
| x | 0.336 | 0.338 | 0.336 |
| y | 0.349 | 0.349 | 0.345 |

From the table, it can be inferred that the tailored compositions also provide excellent values for R_{C}, R_{M} and R_{Y} as well as for the general color rendering index Rₐ. The parameters x and y refer to the coordinates in the well-known CIE 1931 chromaticity diagram. R_{CMY} indicates the average value of R_{C}, R_{M} and R_{Y}. The used phosphors are all Philips phosphors. Ratio's are given in weight. It is estimated that the weight ratios of the phosphors may vary a relative 10% without significantly reducing R_{CMY}.

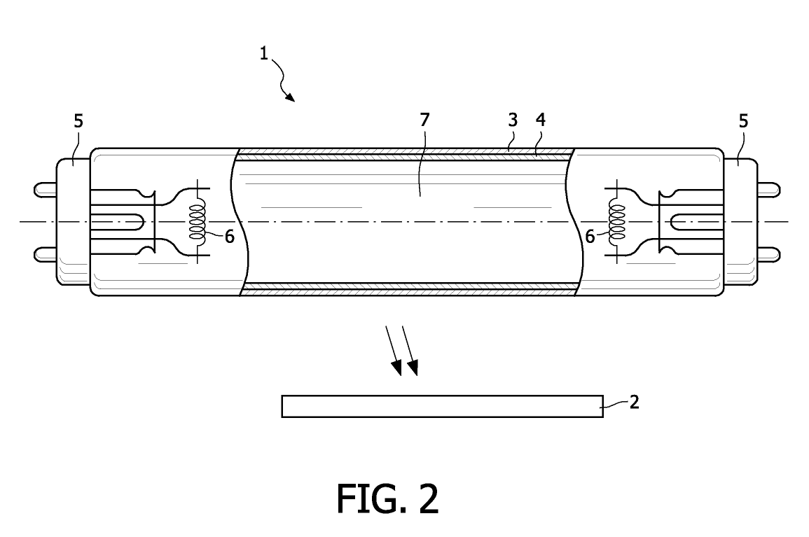

FIG. 2 displays a fluorescent lamp 1 particularly adapted for inspection of color printed matter 2. The fluorescent lamp 1 preferably is a low pressure mercury vapor discharge fluorescent lamp 1, which is generally well-known in the art. The fluorescent lamp 1 has a clear light-transmissive glass tube or envelope 3 which has a circular cross-section. The envelope 3 may contain any kind of transparent and/or translucent material. The inner surface of the envelope 3 is provided with a phosphor-containing layer 4 according to the present invention.

The lamp 1 is hermetically sealed by bases 5 attached at both ends, and a pair of spaced electrode structures 6 (which are means for providing a discharge) are respectively mounted on the bases 5. A discharge-sustaining fill 7 of mercury and an inert gas is sealed inside the glass tube 3. The inert gas is typically argon or a mixture of argon and other noble gases at low pressure which, in combination with a small quantity of mercury, provide the low vapor pressure manner of operation.

The phosphor-containing layer 4 is preferably utilized in a low pressure mercury vapor discharge lamp. It may be used in fluorescent lamps having electrodes as is known in the art, as well as in electrodeless fluorescent lamps as are known in the art, where the means for providing a discharge is a structure which provides high frequency electromagnetic energy radiation.

In the present embodiment, there is only one phosphor-containing layer. Layer 4 contains a blend of six phosphors, e.g. one selected from the above table.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1-4. (canceled)

5. A fluorescent lamp (1) comprising a glass envelope (3) coated with one or more phosphor containing layers (4) and filled with a gas (7), said fluorescent lamp further comprising means (6) capable of discharging said gas, wherein the composition of said phosphor containing layer is tailored to obtain a special color rendering index higher than 93 for at least printing primary colors cyan, magenta and yellow.

6. Fluorescent lamp according to claim 5, wherein the printing primary colors cyan, magenta and yellow are defined according to draft international standard ISO/DIS 2846-5 of 2003.

7. The fluorescent lamp (1) according to claim 5, wherein the special color rendering index for at least printing primary colors cyan, magenta and yellow is at least 93.5, preferably at least 94, preferably at least 95, preferably at least 96, preferably at least 97, preferably at least 98.

8. The fluorescent lamp (1) according to claim 5, wherein at least one of said phosphor containing layers (4) comprises a blend of at least six phosphors.

9. The fluorescent lamp (1) according to claim 5, wherein said phosphor containing layer comprises phosphors selected from Ca₁₀(PO₄)₆F₂:Sb; Ca₁₀(PO₄)₆(F,Cl)₂:Sb,Mn; (Ce,Gd)MgB₅O₁₀:Tb; (Ce,Gd,Tb)MgB₅O₁₀:Mn; Sr₄Al₄O₂₅:Eu; BaMgAl₁₀O₁₇:Eu; BaMg₂Al₁₆O₂₇:Mn and Y₂O₃:Eu.

10. The fluorescent lamp according to claim 9, wherein the phosphor comprises a combination of Ca₁₀(PO₄)₆F₂:Sb; Ca₁₀(PO₄)₆(F,Cl)₂:Sb,Mn; (Ce,Gd)MgB₅O₁₀:Tb; (Ce,Gd,Tb)MgB₅O₁₀:Mn; Sr₄Al₁₄O₂₅ Eu; and BaMgAl₁₀O₁₇:Eu.

11. The fluorescent lamp according to claim 9, wherein the phosphor comprises a combination of Ca₁₀(PO₄)₆F₂:Sb; Ca₁₀(PO₄)₆(F,Cl)₂:Sb,Mn; (Ce,Gd,Tb)MgB₅O₁₀:Mn; Sr₄Al₁₄O₁₅:Eu; BaMgAl₁₆O₂₇:Eu; and BaMg₂Al₁₆O₂₇:Mn.

12. The fluorescent lamp according to claim 9, wherein the phosphor comprises a combination of Ca₁₀(PO₄)₆F₂:Sb; Ca₁₀(PO₄)₆(F,Cl)₂:Sb,Mn; (Ce,Gd,Tb)MgB₅O₁₀:Mn; Sr₄Al₁₄O₂₅:Eu; BaMg₂Al₁₆O₂₇:Mn and Y₂O₃:Eu.

13. Use of the fluorescent lamp (1) according to claim 5 for inspecting color-printed matters (2).
